(19) United States
(12) Patent Application Publication
(10) Pub. No.: US 2023/0327756 A1
(43) Pub. Date: Oct. 12, 2023

(54) COMMUNICATION MONITORING APPARATUS AND COMMUNICATION MONITORING SYSTEM

(71) Applicant: NIPPON TELEGRAPH AND TELEPHONE CORPORATION, Tokyo (JP)

(72) Inventors: Tomoya HATANO, Musashino-shi, Tokyo (JP); Hirotaka UJIKAWA, Musashino-shi, Tokyo (JP); Sei KOU, Musashino-shi, Tokyo (JP); Yuka OKAMOTO, Musashino-shi, Tokyo (JP)

(73) Assignee: NIPPON TELEGRAPH AND TELEPHONE CORPORATION, Tokyo (JP)

(21) Appl. No.: 18/024,926

(22) PCT Filed: Sep. 11, 2020
(86) PCT No.: PCT/JP2020/034395

§ 371 Date: Mar. 6, 2023

(51) Int. Cl. H04B 10/079

(52) U.S. Cl. CPC H04B 10/079

(57) ABSTRACT

Provided is a communication monitoring device and a communication monitoring system capable of monitoring a state of a connection device that forms an optical path by using an optical passive component. A communication management device (8) of a communication monitoring system (1) includes a plurality of photodetectors (11), a plurality of recognition units (14), a processing unit (15), and a transmission unit (16). The photodetectors (11) are provided in a connection device (6). The connection device (6) connects a plurality of optical communication lines (3) by using an optical passive component to form a plurality of optical paths through which optical signals pass. Each photodetector (11) detects an optical signal passing through the corresponding optical path. Each recognition unit (14) recognizes a state of detection of the optical signal by the corresponding photodetector (11). The processing unit (15) generates information regarding a communication state of the connection device (6) on the basis of information regarding the state of detection recognized by each recognition unit (14). The transmission unit (16) transmits the information regarding the communication state of the connection device (6) generated by the processing unit (15) to a receiving unit (9) outside a communication monitoring device (7).

### TECHNICAL FIELD

The present disclosure relates to a communication monitoring device and a communication monitoring system.

### BACKGROUND ART

Patent Literature 1 and Non Patent Literature 1 disclose examples of a communication system. In the communication system, a passive optical network (PON) including a plurality of optical network units (ONUs) and an optical line terminal (OLT) is built. The communication system includes an optical splitter that connects the plurality of ONUs and the OLT. In the communication system of Patent Literature 1, a malfunction of an ONU #1 among the plurality of ONUs is estimated by a warning message issued from the ONU #1. In the communication system, in a case where a message indicating “normal” is obtained from ONUs other than the ONU #1, a malfunction of an optical communication line between the ONU #1 and the optical splitter is estimated.

### CITATION LIST

### Patent Literature

Patent Literature 1: JP 2010-171652 A

### Non Patent Literature

Non Patent Literature 1: GE-PON technology, NTT Technical Review, pp. 91 to 94, September 2005

### SUMMARY OF INVENTION

### Technical Problem

However, the communication system of Patent Literature 1 monitors a malfunction on the basis of messages communicated between the plurality of ONUs and the OLT. Therefore, a state of a connection device such as the optical splitter that connects optical communication lines by using an optical passive component to form optical paths through which optical signals pass is not monitored.

The present disclosure solves such a problem. The present disclosure provides a communication monitoring device and a communication monitoring system capable of monitoring a state of a connection device that forms an optical path by using an optical passive component.

### Solution to Problem

A communication monitoring device according to the present disclosure includes: a plurality of photodetectors provided in a connection device that connects a plurality of optical communication lines by using an optical passive component to form a plurality of optical paths through which optical signals pass, each of the plurality of photodetectors corresponding to any one of the plurality of optical paths and being configured to detect an optical signal passing through the corresponding optical path; a plurality of recognition units, each of the plurality of recognition units corresponding to any one of the plurality of photodetectors and being configured to recognize a state of detection of the optical signal by the corresponding photodetector; a processing unit configured to generate information regarding a communication state of the connection device on the basis of information regarding the state of detection recognized by each of the plurality of recognition units; and a transmission unit configured to transmit the information regarding the communication state of the connection device generated by the processing unit to an external receiving unit.

A communication monitoring system according to the present disclosure includes: the above communication monitoring device; a receiving unit configured to receive the information regarding the communication state of the connection device from the communication monitoring device; and a management unit configured to manage a state of a network including the connection device on the basis of the information received by the receiving unit.

### Advantageous Effects of Invention

A communication monitoring device or communication monitoring system according to the present disclosure can monitor a state of a connection device that forms an optical path by using an optical passive component.

### BRIEF DESCRIPTION OF DRAWINGS

FIG. 1 is a configuration diagram of a communication monitoring system according to a first embodiment.

FIG. 2 is a block diagram of the communication monitoring system according to the first embodiment.

FIG. 3 is a block diagram of a communication monitoring system according to a second embodiment.

### DESCRIPTION OF EMBODIMENTS

Embodiments of the present disclosure will be described with reference to the accompanying drawings. In each drawing, the same or corresponding parts are denoted by the same reference signs, and redundant description will be appropriately simplified or omitted. Note that the present disclosure is not limited to the following embodiments, and it is possible to freely combine the embodiments, modify any component of the embodiments, or omit any component of the embodiments, without departing from the gist of the present disclosure.

### First Embodiment

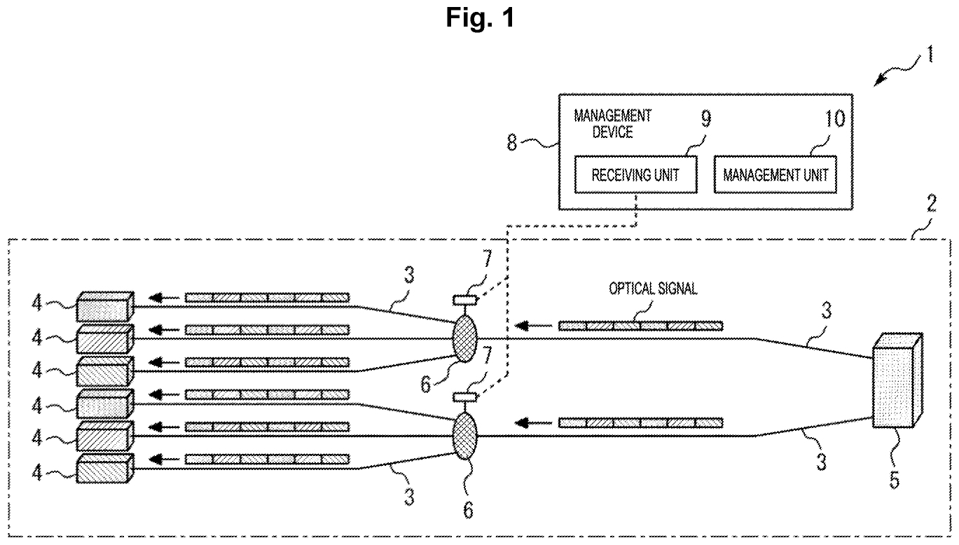

FIG. 1 is a configuration diagram of a communication monitoring system 1 according to a first embodiment.

The communication monitoring system 1 monitors a state of a network in which information is communicated. In this example, the communication monitoring system 1 monitors a state of a PON 2. In the PON 2, information is communicated by optical signals passing through optical communication lines 3. The optical communication lines 3 are, for example, optical fiber cables. The PON 2 includes a plurality of ONUS 4, an OLT 5, and a plurality of connection devices 6.

Each ONU 4 is disposed in a base, house, or the like of a member that receives provision of a communication service in the communication system. For example, each ONU 4 converts an electrical signal from a terminal device or the like that the member uses into an optical signal and transfers the optical signal to the OLT 5. The terminal device that the member uses is, for example, a personal computer.

The OLT 5 is disposed in a base or the like of a service provider that provides the communication service in the communication system. For example, the OLT 5 transfers a signal between the ONUS 4 and an upper network or the like. The upper network is, for example, the Internet.

Each connection device 6 connects the plurality of optical communication lines 3 to form a plurality of optical paths through which optical signals pass. Each optical path is, for example, a path connecting a unit to a unit of the communication system, such as the ONUS 4, the OLT 5, and the connection devices 6. For example, each connection device 6 relays, splits, or combines optical signals passing through the plurality of optical communication lines 3. The connection device 6 may switch the optical paths through which optical signals pass depending on a frequency, for example. In this example, each connection device 6 connects the plurality of optical communication lines 3 connected to some of the plurality of ONUs 4 and the optical communication line 3 connected to the OLT 5 in a one-to-many relationship. The connection device 6 may connect the plurality of optical communication lines 3 connected to the units of the communication system, such as the ONUs 4, the OLT 5, and the connection devices 6, in a many-to-many relationship.

The communication monitoring system 1 includes a plurality of communication monitoring devices 7 and a management device 8.

Each communication monitoring device 7 corresponds to any one of the connection devices 6. Each communication monitoring device 7 is provided in the corresponding connection device 6. Each communication monitoring device 7 monitors a communication state of the corresponding connection device 6. Each communication monitoring device 7 has a function of transmitting the monitored communication state of the connection device 6. The communication monitoring device 7 is, for example, outside the connection device 6 and detachably attached to the connection device 6.

The management device 8 manages information regarding a state of the PON 2. The management device 8 is outside the communication monitoring device 7. The management device 8 includes a receiving unit 9 and a management unit 10. The receiving unit 9 receives information regarding the communication state of each connection device 6. The receiving unit 9 is related to the internet of things (IoT), such as an IoT gateway. The management unit 10 manages the information received by the receiving unit 9. In this example, the management unit 10 manages the information received by the receiving unit 9, for example, accumulates or analyzes the information. The information managed in the management unit 10 is used to, for example, handle a failure in the PON 2.

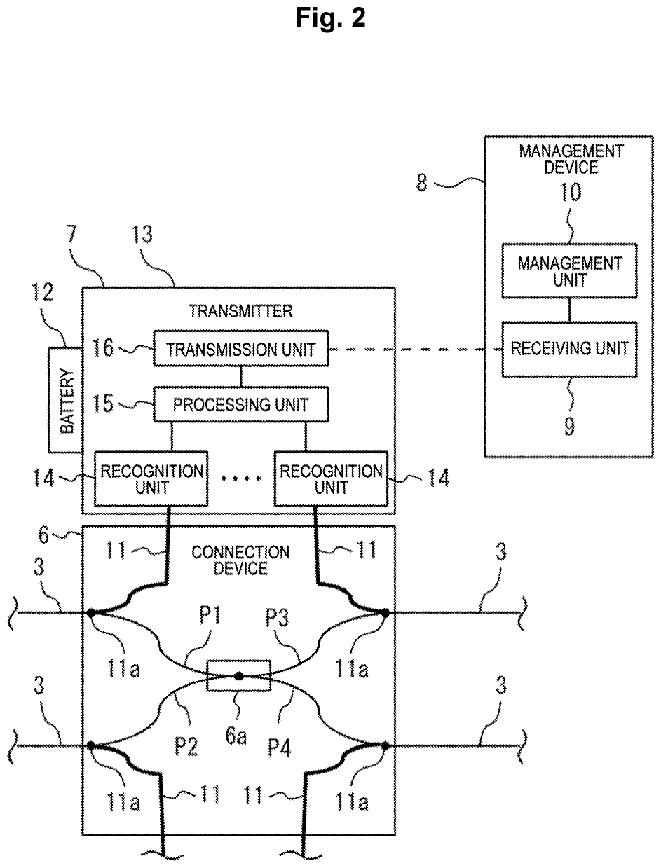

FIG. 2 is a block diagram of the communication monitoring system 1 according to the first embodiment.

In the PON 2 monitored by the communication monitoring system 1, each connection device 6 includes an optical passive component. The connection device 6 connects the plurality of optical communication lines 3 by using the optical passive component. The optical passive component is, for example, an optical coupler, optical splitter, optical patch panel, or optical switch. The optical passive component includes no electrical element. The optical passive component functions without requiring supply of power or the like. That is, the connection device 6 forms an optical path without using an electrical element. Therefore, the connection device 6 hardly fails.

In this example, the connection device 6 forms four optical paths, i.e., an optical path P1, an optical path P2, an optical path P3, and an optical path P4 by using an optical coupler 6a serving as an example of the optical passive component. The connection device 6 splits an optical signal entering from the optical path P1 into the optical path P3 and the optical path P4. The connection device 6 splits an optical signal entering from the optical path P2 into the optical path P3 and the optical path P4. The connection device 6 splits an optical signal entering from the optical path P3 into the optical path P1 and the optical path P2. The connection device 6 splits an optical signal entering from the optical path P4 into the optical path P1 and the optical path P2.

Each communication monitoring device 7 of the communication monitoring system 1 includes a plurality of photodetectors 11, a battery 12, and a transmitter 13. In this example, the communication monitoring device 7 includes the same number of photodetectors 11 as the plurality of optical paths formed by the connection device 6.

The plurality of photodetectors 11 is provided in the connection device 6. Each photodetector 11 corresponds to any one of the plurality of optical paths. The photodetector 11 detects an optical signal passing through the corresponding optical path. The photodetector 11 includes an optical splitter 11a. The optical splitter 11a splits an optical signal passing through the optical path into a main signal and a sub-signal. The optical splitter 11a may split the optical signal into the main signal and the sub-signal as signals having different intensities. At this time, the intensity of the sub-signal is smaller than the intensity of the main signal. Further, the optical splitter 11a may selectively split an optical signal depending on a direction. At this time, among optical signals passing through the corresponding optical path, the optical splitter 11a splits an optical signal entering the connection device 6 into a main signal and a sub-signal. Meanwhile, among the optical signals passing through the corresponding optical path, the optical splitter 11a does not split an optical signal emitted from the connection device 6. The photodetector 11 extracts the sub-signal split by the optical splitter 11a as described above from the corresponding optical path.

The battery 12 supplies power to the transmitter 13. The battery 12 may be, for example, a storage battery that accumulates supplied power. The transmitter 13 may be connected to an external power supply. In this case, the transmitter 13 may normally receive supply of power from the external power supply. Further, the power supplied from the external power supply is normally accumulated in the battery 12. Meanwhile, when a power failure occurs, the transmitter 13 may switch a supply source of power from the external power supply to the battery 12.

The transmitter 13 is related to the IoT, such as an IoT terminal. The transmitter 13 includes a plurality of recognition units 14, a processing unit 15, and a transmission unit 16. In this example, the transmitter 13 includes the same number of recognition units 14 as the plurality of photodetectors 11 included in the communication monitoring device 7.

Each recognition unit 14 corresponds to any one of the plurality of photodetectors 11. Each recognition unit 14 recognizes a state of detection of an optical signal by the corresponding photodetector 11. Each recognition unit 14 receives input of the sub-signal split from the optical path by the corresponding photodetector 11. Each recognition unit 14 recognizes the state of detection of the optical signal by the corresponding photodetector 11 on the basis of the input sub-signal. Each recognition unit 14 may include a light receiving element such as a photodiode that converts the input optical signal into an electrical signal. The state of detection of the optical signal includes, for example, presence/absence of the optical signal passing through the optical path. The state of detection of the optical signal may include an intensity of the optical signal passing through the optical path. Each recognition unit 14 outputs information regarding the recognized state of detection to the processing unit 15.

The processing unit 15 performs information processing of the information output from each recognition unit 14. The processing unit 15 generates information regarding the communication state of the connection device 6 on the basis of the information regarding the state of detection output from each recognition unit 14. The information regarding the communication state of the connection device 6 includes, for example, information regarding presence/absence of an optical signal passing through each optical path. The processing unit 15 performs processing for gathering the states of detection output from the respective recognition units 14 as the information regarding the communication state of the connection device 6. The processing unit 15 performs processing for converting the information regarding the communication state of the connection device 6 into a format processable in the management unit 10. In this example, the processing unit 15 constantly generates the information regarding the communication state of the connection device 6. Alternatively, the processing unit 15 may generate the information regarding the communication state of the connection device 6 once every preset period of time.

The transmission unit 16 outputs the information regarding the communication state of the connection device 6 generated in the processing unit 15 to outside of the communication monitoring device 7. The transmission unit 16 transmits the information regarding the communication state to the receiving unit 9 of the management device 8. In a case where the processing unit 15 constantly generates the information regarding the communication state, the transmission unit 16 constantly transmits the generated information regarding the communication state. Alternatively, in a case where the processing unit 15 generates the information regarding the communication state every preset period of time, the transmission unit 16 transmits the generated information regarding the communication state every preset period of time.

Next, an example of an operation of the communication monitoring device 7 will be described with reference to FIG. 2.

When an optical signal enters the connection device 6 through the optical path P1, the optical splitter 11a of the photodetector 11 corresponding to the optical path P1 splits the optical signal passing through the optical path P1 into a main signal and a sub-signal. The photodetector 11 inputs the sub-signal to the recognition unit 14 corresponding to the photodetector 11. The recognition unit 14 recognizes a state of detection of the optical signal passing through the optical path P1 on the basis of the input sub-signal. The recognition unit 14 outputs the recognized state of detection to the processing unit 15. The optical coupler 6a of the connection device 6 splits the main signal passing through the optical path P1 into the optical path P3 and the optical path P4. In this example, the optical coupler 6a splits the main signal at a split ratio of 1:1. Optical signals split by the optical coupler 6a are emitted from the connection device 6 through the optical path P3 and the optical path P4. At this time, the optical splitter 11a of the photodetector 11 corresponding to the optical path P3 does not split the optical signal passing through the optical path P3. The optical splitter 11a of the photodetector 11 corresponding to the optical path P4 does not split the optical signal passing through the optical path P4.

In this case, the processing unit 15 acquires information indicating that the optical signal passing through the optical path P1 has been detected as information regarding the state of detection. Based on the acquired information, the processing unit 15 generates information regarding a communication state of the connection device 6, the information indicating that the optical signal has been detected in the optical path P1 of the connection device 6.

The transmission unit 16 transmits the information regarding the communication state generated by the processing unit 15 to the receiving unit 9 of the management device 8.

In the management device 8, the management unit 10 accumulates, for example, the information regarding the communication state received by the receiving unit 9 from the transmitter 13. The management unit 10 may analyze a state of the PON 2 on the basis of the accumulated information regarding the communication state. The information accumulated in the management unit 10 may be used to, for example, handle a failure by an operator who performs a maintenance operation of the PON 2.

Next, there will be described an example of a hardware configuration of units or devices of the communication monitoring system 1 including the transmitter 13, the management device 8, and the like. The units or devices of the communication monitoring system 1 include a processing circuit including, for example, a processor and memory as hardware. The processor is, for example, a central processing unit (CPU), arithmetic device, microprocessor, or microcomputer. The memory corresponds to, for example: a nonvolatile or volatile semiconductor memory such as a random-access memory (RAM), read-only memory (ROM), flash memory, erasable programmable read-only memory (EPROM), or electrically erasable programmable read-only memory (EEPROM); magnetic disk; flexible disk; optical disk; compact disk; mini disk; or digital versatile disc (DVD). The memory stores, for example, a program as software or firmware. Further, the units or devices of the communication monitoring system 1 perform preset processing by the processor executing the program or the like stored in the memory, thereby implementing each function as a result of cooperation of hardware and software. The function of each of the units or devices of the communication monitoring system 1 may be implemented by the processing circuit. Alternatively, some or all of the functions of the units or devices of the communication monitoring system 1 may be collectively implemented by the processing circuit. The processing circuit may be implemented by, for example, a single circuit, composite circuit, programmed processor, parallel programmed processor, application-specific integrated circuit (ASIC), field-programmable gate array (FPGA), or combination thereof.

As described above, the communication monitoring system 1 according to the first embodiment includes the communication monitoring devices 7, the receiving unit 9, and the management unit 10. The communication monitoring device 7 includes the plurality of photodetectors 11, the plurality of recognition units 14, the processing unit 15, and the transmission unit 16. The plurality of photodetectors 11 is provided in the connection device 6. The connection device 6 connects the plurality of optical communication lines 3 by using an optical passive component to form a plurality of optical paths through which optical signals pass. Each photodetector 11 corresponds to any one of the optical paths. Each photodetector 11 detects an optical signal passing through the corresponding optical path. Each recognition unit 14 corresponds to any one of the photodetectors 11. Each recognition unit 14 recognizes a state of detection of the optical signal by the corresponding photodetector 11. The processing unit 15 generates information regarding a communication state of the connection device 6 on the basis of information regarding the state of detection recognized by each recognition unit 14. The transmission unit 16 transmits the information regarding the communication state of the connection device 6 generated by the processing unit 15 to the receiving unit 9 outside the communication monitoring device 7. The receiving unit 9 receives the information regarding the communication state of the connection device 6 from the communication monitoring device 7. The management unit 10 manages a state of a network such as the PON 2 including the connection device 6 on the basis of the information received by the receiving unit 9.

With such a configuration, when the communication monitoring device 7 is applied to the connection device 6 that forms an optical path by using an optical passive component, it is possible to monitor a state of the connection device 6 including no electrical element. Therefore, even in a case where a wiring error, disconnection of the optical communication line 3 connected by the connection device 6, or the like occurs, it is possible to confirm the state of the network by using the management device 8 or the like, without checking the actual error or disconnection. This increases an operation rate of the network. In particular, the state of the network can be more efficiently managed in a case where a large number of connection devices 6 are scattered in various positions. In a case where the communication monitoring device 7 is attached as an external device, a main signal in the connection device 6 is hardly affected even in a case where the communication monitoring device 7 fails. In a case where the battery 12 is provided in the communication monitoring device 7, monitoring continues even in a case where supply of power from the external power supply is stopped when a power failure occurs, for example. Because the connection device 6 itself does not require power supply, a main signal in the connection device 6 is hardly affected even when a power failure occurs, for example. Note that, for example, in a case where the connection device 6 is not monitored when a power failure occurs, the communication monitoring device 7 may not include the battery 12.

The processing unit 15 generates information including presence/absence of the optical signal passing through each optical path as the information regarding the communication state of the connection device 6. Therefore, a communication state of the individual optical path in the connection device 6 is grasped, and thus it is possible to more efficiently manage the state of the network by using more detailed information.

Each photodetector 11 splits the optical signal passing through the corresponding optical path. Each recognition unit 14 recognizes the state of detection of the optical signal by the corresponding photodetector 11 on the basis of the optical signal split by the photodetector 11. Therefore, the photodetector 11 is formed without using an electrical element.

Each photodetector 11 splits the optical signal passing through the optical path into a main signal and a sub-signal. The intensity of the sub-signal is smaller than the intensity of the main signal. Each recognition unit 14 recognizes the state of detection of the optical signal by the corresponding photodetector 11 on the basis of the sub-signal split by the photodetector 11. Therefore, a decrease in the intensity of the main signal caused by monitoring can be reduced.

Each photodetector 11 splits an optical signal entering the connection device 6 among optical signals passing through the corresponding optical path. Each recognition unit 14 recognizes a state of detection of the optical signal by the corresponding photodetector 11 on the basis of the optical signal entering the connection device 6 and split by the photodetector 11. Therefore, even in a case where the connection device 6 splits an optical signal, the optical signal is detected on an upstream side of the split, and thus it is clear in which optical path the optical signal is detected. This generates information regarding the communication state of the connection device 6 with which the state of the network is more easily grasped.

The transmission unit 16 may transmit the information regarding the communication state of the connection device 6 every preset period of time. Therefore, the information regarding the communication state is not transmitted more than necessary, and thus an amount of communication between the communication monitoring device 7 and the management device 8 is saved. Further, there is no need to generate the information regarding the communication state that is not transmitted, and thus power consumption in the communication monitoring device 7 is saved.

Note that the communication monitoring system 1 or an optical communication system monitored by the communication monitoring device 7 may be any optical communication system to which the connection device 6 that forms an optical path by using an optical passive component is applied and is not limited to the PON 2. The communication monitoring system 1 or the communication monitoring device 7 may monitor a state of an optical communication system other than the PON 2. The connection device 6 may be, for example, optical switches provided at both ends of a transmission section of the optical communication system. The transmission section may be, for example, a section of communication using a submarine cable or a section of communication to a remote location such as a remote island. The optical switches at both the ends of the transmission section are used to, for example, switch communication paths in a case where communication lines such as submarine cables in the transmission section are duplicated and one of the duplicated submarine cables fails.

### Second Embodiment

In a second embodiment, points different from the example disclosed in the first embodiment will be described in particular detail. Any feature of the example disclosed in the first embodiment may be adopted as a feature not described in the second embodiment.

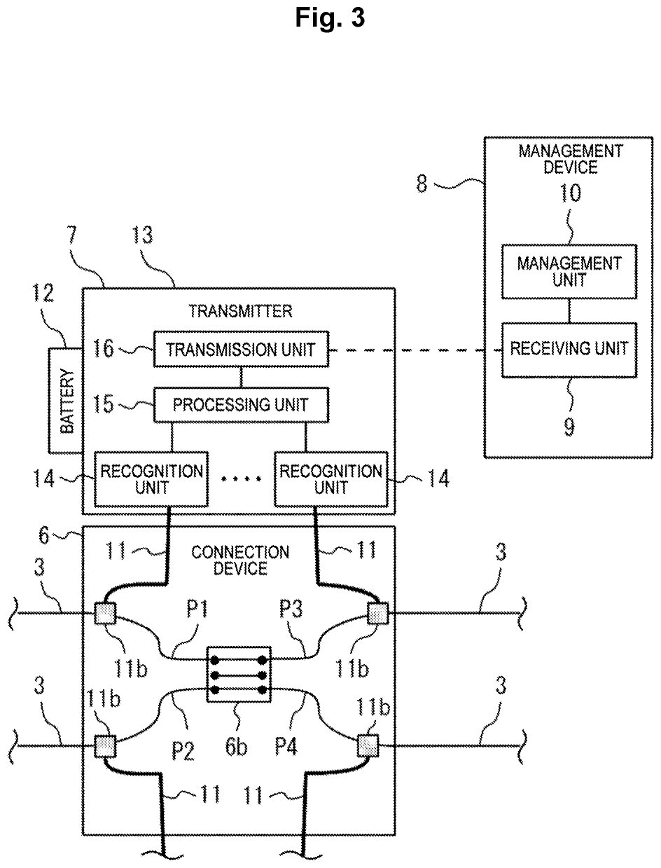

FIG. 3 is a block diagram of the communication monitoring system 1 according to the second embodiment.

In this example, the connection device 6 forms four optical paths, i.e., the optical path P1, the optical path P2, the optical path P3, and the optical path P4 by using an optical patch panel 6b serving as an example of the optical passive component. The connection device 6 relays an optical signal entering from the optical path P1 to the optical path P3. The connection device 6 relays an optical signal entering from the optical path P2 to the optical path P4. The connection device 6 relays an optical signal entering from the optical path P3 to the optical path P1. The connection device 6 relays an optical signal entering from the optical path P4 to the optical path P2.

Each photodetector 11 of the communication monitoring device 7 includes a light receiving element 11b provided in the corresponding optical path. The light receiving element 11b is, for example, an element such as a photodiode that converts an optical signal passing through the optical path in which the light receiving element is provided and outputs a detection signal. The detection signal is, for example, a signal whose format is recognizable by the recognition unit 14, such as an electrical signal. The light receiving element 11b detects, for example, light leaking from the optical path. Each recognition unit 14 recognizes a state of detection of the optical signal by the corresponding photodetector 11 on the basis of the detection signal output by the photodetector 11. Each recognition unit 14 outputs information regarding the recognized state of detection to the processing unit 15. The processing unit 15 generates information regarding a communication state of the connection device 6 on the basis of the information regarding the state of detection output from each recognition unit 14. The transmission unit 16 transmits the information regarding the communication state of the connection device 6 generated in the processing unit 15 to the receiving unit 9 of the management device 8. Note that each photodetector 11 may convert a sub-signal split from the corresponding optical path by an optical splitter or the like into a detection signal by using the light receiving element.

As described above, each photodetector 11 of the communication monitoring device 7 according to the second embodiment converts an optical signal passing through the corresponding optical path and outputs a detection signal. Each recognition unit 14 recognizes a state of detection of the optical signal by the corresponding photodetector 11 on the basis of the detection signal output from the photodetector 11. Therefore, the recognition unit 14 receives the detection signal whose format is directly recognizable, such as an electrical signal, and thus recognition processing in the recognition unit 14 becomes easy.

### INDUSTRIAL APPLICABILITY

A communication monitoring system according to the present disclosure is applicable to monitoring a state of a network in which information is communicated by an optical signal. Further, a communication monitoring device according to the present disclosure is applicable to the communication monitoring system.

### REFERENCE SIGNS LIST

1 Communication monitoring system
2 PON
3 Optical communication line
4 ONU
5 OLT
6 Connection device
6a Optical coupler
6b Optical patch panel
7 Communication monitoring device
8 Management device
9 Receiving unit
10 Management unit
11 Photodetector
11a Optical splitter
11b Light receiving element
12 Battery
13 Transmitter
14 Recognition unit
15 Processing unit
16 Transmission unit

1. A communication monitoring device comprising:
a plurality of photodetectors provided in a connection device that connects a plurality of optical communication lines by using an optical passive component to form a plurality of optical paths through which optical signals pass, each of the plurality of photodetectors corresponding to any one of the plurality of optical paths and being configured to detect an optical signal passing through the corresponding optical path;
a plurality of recognition units, each of the plurality of recognition units corresponding to any one of the plurality of photodetectors and being configured to recognize a state of detection of the optical signal by the corresponding photodetector;
a processing unit configured to generate information regarding a communication state of the connection device on the basis of information regarding the state of detection recognized by each of the plurality of recognition units; and
a transmission unit configured to transmit the information regarding the communication state of the connection device generated by the processing unit to an external receiving unit.

2. The communication monitoring device according to claim 1, wherein
the processing unit generates information including presence/absence of the optical signal passing through each of the plurality of optical paths as the information regarding the communication state of the connection device.

3. The communication monitoring device according to claim 1, wherein:
each of the plurality of photodetectors splits the optical signal passing through the corresponding optical path; and
each of the plurality of recognition units recognizes the state of detection of the optical signal by the corresponding photodetector on the basis of the optical signal split by the photodetector.

4. The communication monitoring device according to claim 3, wherein:
each of the plurality of photodetectors splits the optical signal passing through the corresponding optical path into a main signal and a sub-signal having a smaller intensity than an intensity of the main signal; and
each of the plurality of recognition units recognizes the state of detection of the optical signal by the corresponding photodetector on the basis of the sub-signal split by the photodetector.

5. The communication monitoring device according to claim 3, wherein:
each of the plurality of photodetectors splits an optical signal entering the connection device among optical signals passing through the corresponding optical path; and
each of the plurality of recognition units recognizes a state of detection of the optical signal by the corresponding photodetector on the basis of the optical signal entering the connection device and split by the photodetector.

6. The communication monitoring device according to claim 1, wherein:
each of the plurality of photodetectors converts the optical signal passing through the corresponding optical path and outputs a detection signal; and
each of the plurality of recognition units recognizes the state of detection of the optical signal by the corresponding photodetector on the basis of the detection signal output from the photodetector.

7. The communication monitoring device according to claim 1, wherein
the transmission unit transmits the information regarding the communication state of the connection device every preset period of time.

8. A communication monitoring system comprising:
the communication monitoring device according to claim 1;
a receiving unit configured to receive the information regarding the communication state of the connection device from the communication monitoring device; and
a management unit configured to manage a state of a network including the connection device on the basis of the information received by the receiving unit.
